(19) United States
(12) Patent Application Publication
(10) Pub. No.: US 2003/0077362 A1
(43) Pub. Date: Apr. 24, 2003

(54) Encapsulated flavors as inclusion in candy confections

(76) Inventors: Dorothy A. Panhorst, Morristown, NJ (US); Kenneth John Klacik, Hillsborough, NJ (US); John S. Kitt, Sparta, NJ (US); Paul O. Campbell, Easton, PA (US); Dan Worthy, Succasunna, NJ (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/045,335

(22) Filed: Oct. 23, 2001

(51) Int. Cl. A23G 1/00

(52) U.S. Cl. 426/103

(57) ABSTRACT

A candy product is prepared using as a flavor component a flavorant particle which comprises a hydrophilic flavor encapsulated within a water soluble shell. The candy may be a hard candy, chewy candy, a gummy or jelly candy, a paste lozenge, tablet licorice, or a pan coated candy.

### TECHNICAL FIELD

This invention relates to the use of encapsulated flavors in a variety of candy products including hard candies, chewy candies such as toffee and caramel, gummy and jelly candies, paste lozenges, tablets, licorice and pan coated candies. The encapsulated flavors comprise an oil based liquid component which is contained within a natural polymer shell, such as gelatin.

### BACKGROUND OF THE INVENTION

Gums and candies containing encapsulated flavoring components are popular consumer products. Various methods for preparing such products have been described. See, for example, U.S. Pat. No. 5,014,595 to Cherukuri which is incorporated herein by reference and which describes a free flowing particulate delivery system comprising a powdered flavor composition encapsulated in a matrix comprising a hydrophilic coating. Cherukuri cites many other teachings involving flavor encapsulation technologies, including methods wherein (1) flavor oils are coextruded with a water soluble sugar, dried and ground for use; (2) flavors are encapsulated within high molecular weight materials such as polyvinyl acetate; (3) volative flavors are encapsulated in a fat or wax; and (4) flavors are encapsulated within multiple layers of coatings.

See also U.S. Pat. No. 5,532,004 to Bell which is incorporated herein by reference. Bell describes a chewing gum composition which contains a flavoring component which consists of particles of one or more hydrophilic flavorants encapsulated in a hydrophilic shell. The shell may be composed of a hydrophilic, or water soluble, shell-forming material, such as gelatin, agar, shellac and xanthan gum. The flavorants taught by Bell include natural and artificial flavors such as oil of peppermint, oil of spearmint, vanilla, oil of cinnamon, oil of wintergreen, lemon oil, orange oil, grapefruit oil and others.

Bell states that the encapsulated flavoring component may be prepared by the techniques described in European Patent Application 89303098.1, which teaches mixing the desired hydrophilic shell material in an aqueous solution, adding the hydrophilic flavorant in droplet amounts, agitating the system, and then causing the hydrophilic component to become solid by use of various techniques, including pH adjustment, salt additions or cooling. Using this process, solid particles of encapsulated flavor may be recovered and dried. Presently there are several commercial sources for oil soluble, encapsulated flavors, wherein the encapsulant is gelatin. These sources include food ingredient suppliers and distributors.

According to Bell, the advantages which the described flavorant particles impart to gum include (1) enhancing the perception of flavor, while using less flavorant, and (2) preventing the flavor from being masked within the gum base, and (3) preventing flavor from being lost during gum processing steps.

Another teaching involving the use of encapsulated flavor oils is found in U.S. Pat. No. 5,759,599 to Wampler which is also incorporated herein by reference. Wampler describes a process wherein a flavor oil such as lemon oil is encapsulated in a gelatin, and wherein the filled gelatin capsules are then cross-linked by reaction with glutaraldehyde. See Wampler's Example D. The result is a strengthened gelatin flavor capsule which will withstand elevated temperatures when it is added to foods such as raw dough products prior to cooking.

In one aspect the present invention may be considered a variant of liquid centered candies. Liquid center candies, as such, are favorites of many candy lovers. They provide a variety of textures and a level of interest not realized by many other candies, and provide a unique and recognizable point of difference to consumers. They are often produced with the same flavor as the exterior and sometimes with a complimentary, different flavor.

Among the various types of liquid center candy products are jelly candies, chocolate creams, and the like. Typically, the center is not liquid when the product is made, but is liquefied later.

In U.S. Pat. No. 5,626,896, Moore describes a method for making liquid-centered jelly candies. According to that description, jelly candy is processed to achieve a moisture content of from about 25-30% and is then deposited in a starch mold to a level that half fills the mold. A small hard candy pellet is made from sugar, color, flavor, and acidulate. The hard candy pellet is centered on the jelly candy in each of the half full molds. A second deposit of warm jelly candy is filled over the pellets completing the candy pieces. The candy is cured at about 130.degree. F. to about 140° F. for from about 24 to 48 hours. During curing, moisture from the jelly candy migrates to and liquifies each candy pellet forming the liquid-centered jelly candy. The completed candy pieces are cured in the molds at about 130° F. to about 140° F. for about 24-48 hours. During the curing process, the moisture from the jelly migrates into and liquefies the sugar paste forming a liquid-centered jelly candy.

Presently, various procedures are used to manufacture liquid-center candies; such as fondant/invertase liquefaction, center fill co-extrusion, injection filling and center-in-shell co-depositing.

Fondant/invertase liquefaction is generally accomplished by mixing the enzyme, invertase, in a fondant that is enrobed with chocolate. The enzyme later converts the fondant to a liquid by breaking down sucrose to invert sugar. The enzymatic action is dependant on the amount of available moisture, pH, and temperature. This method does not work well with jelly candy because of the jelly candy's low moisture content. Jelly candy is put into the molds at about 25-30% moisture and then cured at 140° F. for further drying. Thus, by the time the invertase has time to liquify the center filling, there is not enough water remaining for invertase action.

Center fill co-extrusion is generally used to fill hard candy with jam-like material. The first step is to form a rope of hard candy. Second, a small pipe that sticks into the hard candy is used to pump jam into the candy. The rope of candy is then run through cutters, and pinched to form seams. This method is specific for hard candy, taffy or other high-cooked candy. However, center fill co-extrusion does not work with jelly candy, because there are problems with seal failure.

Center shell depositing uses a depositing nozzle that has a concentric design so that it can pump an outer stream and a center stream at the same time. Pumping is timed so that the outer shell is pumped into the mold first, and then the inside stream comes on after a sleeve of outer candy is created with the initial deposit. It is successfully used to fill peanut butter, fondant and other paste like fillings into chocolate. However, filling thin liquid into jelly candy has not been well demonstrated by this method due to excessive leaks. Leaks are more likely to develop with jelly candy than with other types of candy for several reasons. First, because of the density of sugary liquids, they will sink through hot jelly to the bottom of the mold. As a result, leaks will develop, because the bottom of the piece of candy will have a thin wall. Third, if pump timing is even slightly irregular, filling will be slightly to the side. This will create a thin outer wall, and creates potential for a leak. If the cut off on the nozzle isn't perfectly timed and a string of the inner liquid comes up through the outer jelly, a leak pathway will develop. Fourth, jelly candies tend to shrink and contract as they are dried. This gives them a pressurized effect. If there is any leaker pathway within jelly candy, the liquid is squeezed out of the center.

Since flavors are better perceived in liquid than in colloidal jelly, a free flowing liquid center offers uniquely pleasant eating qualities and delivers a pronounced flavor advantage over solid jelly candy. Texture and eating qualities are improved by the liquid lubrication of the jelly mass during mastication. Additionally, liquid center jelly preparations may have pharmaceutical applications in situations in which the desired dose form is liquid.

Since liquid centers are desirable and present methods for preparing liquid-centered jelly candy are inadequate, a demand exists for a process to prepare a variety of candies.

Confectionery products such as hard candies, chewy candies, gummy and jelly candies, paste lozenges, tablets, pan coated candies and licorice present unique flavoring issues, and while liquid flavorants or pockets of such flavoring have long been utilized in a variety of candy products as described above, heretofore flavorant particles such as are used by Bell for chewing gum have not been utilized in candy products.

In part, the reason why flavor particles such as are used by Bell in gum are not used in other confections involves the fact that processing conditions may differ significantly from the processing conditions employed in chewing gum manufacture. In addition, the environment within candies presents a variety of internal, candy-specific conditions, which may differ greatly from conditions within chewing gums.

The following briefly summarizes the types and function of several of the major flavorants in candy.

While sugar provides sweetness and acid tartness, it is the flavoring agent that provides taste to a candy confection. Examples of candy flavorings are natural flavors like vanilla, citrus oils and essential oils. Also employed are the true flavors obtained from fruits and berries.

In some cases, true fruit flavors are blended with imitation flavors to make them more like the flavor of the original fruit. Such combination true-imitation blends are more stable and better resist higher temperatures than their counterparts. Flavor strength, too, may be increased several-fold.

Imitation flavors are mixtures of aromatic chemicals designed to simulate natural flavors. An imitation grape flavor, for instance, may contain methyl anthranilate, ethyl caproate, benzyl propionate, or benzylidene acetone in predetermined amounts as is well known in the art.

Flavors are also incorporated into candies from sources other than fruits, berries, and imitation preparations. For example, during cooking, sugars are caramelized to create a caramel flavor. Other sweeteners—honey, molasses, brown sugar, and maple sugar—are also added for their unique flavors. Cocoa, chocolate, milk, cream, butter, margarine, etc., also contribute specific flavors to candies. See generally “Candy Technology, AVI Publishing, 1979”.

The following is a brief description of the types of candies to which the present invention is applicable.

Hard Candy

Hard candies are prepared from high temperature cooking of sugar and water. Included in hard candy formulations are ingredients such as corn syrup, invert sugar and cream of tartar. Additionally, cream, cocoa powder and the like may be added. These are cooked to low moistures which are generally in the range of 0.5. to 3.5%, but may sometimes reach up to 5%. Frequently, colors and flavorings are added and the candies may be color striped or center-filled.

Chewy Candies

Chewy candies include caramel, taffies and toffee type candies. These are dairy based products and frequently contain fresh cream, but also may be made from skim or fresh whole milk, unsweetened evaporated milk, sweetened condensed milk or reconstituted milk solids. Toffees are basically high-cooked caramels.

Gummy and Jelly Candies

Gummy and jelly candies typically are prepared from a boiled mixture of mixed sugars which is then blended with a gelling agent and processed into any of a wide range of shapes by depositing into starch moulds. A number of gelling agents may be utilized among which are starch, gelatin, pectin, gum arabic and agar. The foregoing is known as a Mogul process. The candies can also be extruded or simply cast onto a slab or cast into rubber moulds. The pieces are then held to set and dry. For a general description of this type of process, see Lees and Jackson; Sugar Confectionery and Chocolate Manufacture; 1973 (ISBN 0249 44120 9); pages 226-268, which is incorporated by reference herein.

Paste Lozenges

Lozenges consist of a sugar dough which as been flavored, cut to shape and subsequently dried to remove added water. The dough normally contains a mucilage, or binder, usually a solution of gum and gelatins, which is added to assist in retention of shape.

These candies are typically prepared employing a simple process which involves mixing the gum and gelatin mucilage with powdered sugar and flavor, followed by air drying.

Tablets

Tablets are mixtures of flavorings, lubricants, such as stearic acid in isopropanol, and a binding agent, such as gelatin and base material. The mixture is held together under pressure to form a low moisture confection which is hard and cohesive. Tablets are conventionally prepared by both slugging and wet granulation procedures.

Licorice

Licorice is a confection manufactured from a paste which usually includes treacle, wheat flour, licorice extract and caramel, along with many other optional ingredients. Treacle is a dark, viscous liquid with a distinctive bitter back-taste. It consists of cane molasses to which sugar syrups have been added. The wheat flour acts as a bulking and gelling agent. Licorice is typically prepared by pre-mixing the ingredients and then cooking at 120° C.-145° C. in a cooker such as a scrape surface heat exchanger. The cooked licorice may then be extruded as ropes and cut into cylinders.

Panned Candies

These candies are cold-processed in unheated revolving pans. Included in this category are jelly eggs, jelly beans and marshmallows.

### SUMMARY OF THE INVENTION

An object of the invention is to provide a candy product containing an encapsulated flavor component.

It is another object of the invention to provide novel candy products wherein flavors are protected against degradation.

It is another object of the invention to provide a novel flavoring system which may be adapted for use in hard candies, chewy candies, gummy and jelly candies, paste lozenges, tablets, licorice and pan coated candies.

It is another object of the invention to provide a novel flavoring system which may be utilized to incorporate a number of distinct flavors into a single candy piece.

It is another object of the invention to provide a candy having a liquid-filled portion that is protected during processing by a coating which dissolves in the mouth slowly or can be ruptured to release the liquid center.

It is another object of the invention to provide a process for preparing candies having liquid components wherein the liquid component can be preformed and supplied as needed to candy forming apparatus.

It is yet another object of the invention to provide a process for preparing candies having liquid components which permits easy change from one flavor liquid to another or the easy preparation of randomly flavored pieces.

These and other objects of the invention are accomplished by the present invention which provides flavor capsules consisting of gelatin encapsulated flavorants prepared so as to provide flavor containment within the candy piece.

### DETAILED DESCRIPTION OF THE INVENTION

This invention is based upon the finding that suitably constructed flavor capsules will maintain structural integrity within a variety of types of candy pieces and thereby provide a novel and enhanced flavor delivery means. Candy pieces which may be flavored using the system include hard candies, chewy candies, gummy and jelly candies, paste lozenges, tablets, licorice and pan coated candies.

The natural polymer based capsules which contain or encapsulate the oil based flavors may be of various sizes. It is possible to have quite large flavor capsules, such that, e.g., a single large sphere-shaped hard candy would contain a single flavor capsule. This, in effect, would comprise a liquid center confection, with the liquid comprising an oil based flavoring component. In such an embodiment the flavor capsule might have a diameter in the range of approximately 3 mm-8 mm. When one or more flavor capsules with the diameters in the range of 6 mm-8 mm are within a single confection, the candy will impart a distinct feel of liquid release within the mouth of the consumer as the capsules are burst. Other embodiments with smaller capsules may, however, be preferred when the flavor within the capsule is of particularly high intensity. In such other embodiments the flavor containing capsules might be rather small, in the range of 0.1 mm to 1.0 mm, but might have sizes up to 3.0 mm in diameter. When the capsules are at the higher end of this lower range, i.e. 1.0 mm to 3.0 mm in diameter, the flavorant within the capsule provides a distinct “flavor burst” when the confection is chewed or allowed to melt in the mouth, but there is not the same feel of liquid release as is experienced with larger (3 mm-8 mm) capsules.

As will be appreciated by those skilled in the art, processing conditions for various candies vary greatly in terms of temperatures employed. Similarly, moisture levels present in candy mixes and finished candy products are subject to great variation. For that reason, in some instances it may be necessary to strengthen the capsule shell in order that the shell maintain its integrity. To that end, the shells may be strengthened by the use of suitable exposure to cross-linking agents, using processes well known in the art, prior to being mixed with confections.

### EXAMPLES

The following examples are presented to further illustrate and explain the present invention and should not be taken as limiting in my regard. Unless otherwise indicated, all parts and percentages are by weight, and are based on the weight at the particular stage of the process being described.

### EXAMPLE 1

### Fruit Flavored Lozenges

A fruit flavored lozenge was prepared according to the following procedure:

A mucilage was prepared from 120 g of gum arabic, 241 g water, 9 g gelatin and an additional 30 g of water. A batch was then prepared having the following composition:

| | g | % |
|---|---|---|
| mucilage | 60 | 11.6 |
| 6x powdered sugar | 432.5 | 83.7 |
| grapefruit capsules | 2.5 | 0.5 |
| (gelatin capsules containing | | |
| grapefruit oil flavoring) | | |
| grapefruit flavors | 4.5 | 0.9 |
| citric acid (powdered) | 15.0 | 2.9 |
| yellow #5, 2% solution | 2.5 | 0.5 |

The batch was kneaded together in a mixing bowl to form a stiff paste. The paste was then rolled out to form a sheet approximately 0.25 inch thick. Lozenges were stamped from the sheet into disks of 0.5 inch diameter. The lozenges were then dried at room temperature for 24 hrs. After 24 hours the product was transferred to a forced air oven and dried for 48 hours 100° F. The batch was inverted after 24 hours to promote even drying.

The lozenges had a clean, grapefruit, taste and when chewed, the flavor capsules imparted bursts of grapefruit oil flavor, which noticeably augmented the grapefruit flavor of the base candy.

### EXAMPLE 2

### Chewy Candy

A chewy candy containing gelatin-based peppermint containing capsules was prepared according to the following procedure:

A syrup was prepared according to the following formula:

| | |
|---|---|
| Sugar | 750 g |
| Water | 200 g |
| Corn syrup 43/43 | 750 g |

The syrup batch was boiled to 275° F., then blended with 200 g of Fondax in a Hobart mixer. At that point the following ingredients were added and mixed in.

| | | |
|---|---|---|
| 250 bloom gelatin | 25 | g |
| Water | 35 | g |
| Hydrogenated vegetable oil | 150 | g |
| (paramount B) | | |
| Peppermint capsules | 10 | g |
| (gelatin capsules containing | | |
| peppermint oil flavoring) | | |
| Blue #1, 1% soln | 3 | drops |

Once blended, 3 g of prewetted crystal white peppermint oil and 4 g of sugar lecithin were added.

The entire batch was then poured onto silicone paper, cooled and cut into 1 inch×10 mm cubes and twist wrapped into polypropylene film.

As with the grapefruit lozenges, these chewy candies had a clean taste and when the confections were chewed the flavor capsules imparted bursts of peppermint flavor, which noticeably augmented and was distinct from the underlying peppermint flavor.

### EXAMPLE 3

### Chewy Mint

Chewy mints with peppermint capsules were prepared according to the following procedure:

| | Formulas: |
|---|---|
| Chewy Mints: | Gms |
| Versa Whip 600 | 6 |
| Water | 80 |
| 10X Pd. Sugar | 137 |
| Gelatin 250 Bloom | 17 |
| Water | 51 |
| Sugar | 600 |
| Water | 200 |
| Corn Syrup 43/43 | 800 |
| Star Dri 100 | 80 |
| Part. Hyd. Coconut oil | 150 |
| Crystal White Peppermint Oil | 2 |
| Peppermint Capsules | 10 |
| (gelatin capsules containing | |
| peppermint oil) | |
| Blue #1 (1% sol) | Trace |

The Versa Whip and Powdered Sugar were dry blended in a Hobart mixer for 5 mins. the 80 mins water was then added and the batch mixed at slow speed for 3 mins. The speed was then increased to high and the batch beaten to a stiff peak (6 Mins).

The gelatin was dissolved in 51 gm water@160° F., and the 200 gms water, sugar, corn syrup and Star Dri were added to a steam kettle and boiled to 262° F.

The boiled batch was blended into the frappe in the Hobart mixer and followed by the Coconut Oil, lecithin, gelatin sol and peppermint capsules. After a minimum blending time consistent with incorporating all phases of the formula, the batch was spread out in a 1/2″ sheet on silicone paper, cooled to room temperature and cut up into bite sized pieces and wrapped in wax paper.

These chewy candies has a clean peppermint flavor, and when chewed the candies exhibited bursts of flavor as the flavor capsules broke. Again, the flavor of the oil from the bursting capsules was distinct from and clearly added to the underlying peppermint flavor.

### EXAMPLE 4

### Multi-Flavored Hard Candy

A hard candy was prepared in a conventional manner from a pre-mix containing sugar, corn syrup blend; the sugar:corn syrup ratio being 60:40 on a dry weight basis. The corn syrup was a high maltose (65% maltose) syrup which contained 80% solids.

This premix was cooked in an open kettle at a temperature in the 270° F.-310° F. range and yielded a candy with 2-4.5% moisture. Alternatively, the candy could have been cooked continuously or batched with or without a vacuum.

After cooking the pre-mix, 0.2% by weight flavor, 0.7% by weight malic acid and 0.7% by weight sodium lactate buffer solution, along with color, were added. Encapsulated flavors consisting of oil based flavors in gelatin shells were also added at this stage. The capsules were added to the candy mix after cooking and before forming, at temperatures of 270 degrees F.-295 degrees F. The candy was then deposited into Teflon lined candy molds, cooled in a cooling tunnel and wrapped. Alternatively, the capsules could have been added to a depositor hopper with agitation, or to the candy matrix in the case of a die-formed candy. The flavor within the capsules was chosen to be a flavor different from the conventional flavor component. Thus, the candy, when sucked or chewed, gave flavor “bursts” when capsules were consumed, and the flavor of the bursts momentarily overpassed the outer candy flavor.

Although these hard candy pieces were formed using a conventional depositing procedure, in place of depositing into molds, the candy could have been spun or formed in a rotary die.

### EXAMPLE 5

### Gummy Candy

A gummy candy may be is prepared according to the following procedure.

A base may be prepared as follows:

| | lbs/bath | lbs solids | % |
|---|---|---|---|
| water | 41 | 0 | |
| sugar | 264.8 | 263.5 | 38.87 |
| corn syrup | 272.4 | 217.9 | 32.15 |
| (43 Be, 42DE) | | | |
| corn syrup | 141.4 | 114.4 | 16.88 |
| (53 Be, 62DE) | | | |
| citric acid | 12.5 | 12.5 | 1.34 |
| gelatin slurry | 150.2 | 47.2 | 6.96 |
| (250 Bloom) | | | |
| sorbitol | 32 | 22.4 | 3.30 |
| TOTAL | 939.3 | 673.2 | 100.00 |

The base may be cooked in a customary fashion to 77% solids. The base material may then be transferred to a color/flavor/acid station where selected quantities of base may be weighed out and liquid color, flavor and acid added.

| | lbs/bath | lbs solids | % |
|---|---|---|---|
| cooked base | 874.3 | 673.2 | 99.28 |
| lemon flavor | 2.35 | 2.35 | 0.35 |
| F.D.&C. Yellow #5 | 0.56 | 0.016 | 0.002 |
| (2.75% solution) | | | |
| citric acid | 5.04 | 2.52 | 0.37 |
| (50% solution) | | | |
| TOTAL | 882.26 | 678.10 | 100.00 |

The colored, flavored and acidified base may be delivered to a mogul for casting into starch trays. The mogul should be equipped with at least two depositing heads and at least one gelatin capsule delivery device. While passing under a first depositing head, the starch cavity may be filled with up to half of the required base. The starch board maybe then passed under a gelatin capsule delivery device where flavor capsules may be imbedded into the surface of the candy base. The board may then be moved under a subsequent depositing head and topped off with base material to produce candy pieces.

The candy may then be conveyed into a curing/drying room where the gelatin structure can mature and the candy pieces may lose up to 8% moisture.

The product may then be demoulded, de-dusted, oiled (to prevent stickiness) and packaged.

The flavor capsules which are less dense than the base, will float when added to the liquid base in a conventional matter. Even if the capsules stay dispersed in the base, the head of the depositor has small channels and nozzles which may get clogged by the capsules. In addition, the acid flavor system may adversely impact the integrity of the capsules. By adding the capsule in the above-described manner, the integrity of the capsules is preserved, resulting in high intensity bursts of flavor or multiple flavors which otherwise can not be achieved using conventional ingredients and processing techniques.

What is claimed is:

1. A hard candy comprising a flavoring component consisting of a hydrophilic flavor encapsulated within a gelatin shell.

2. A candy according to claim 1 wherein the liquid flavoring portion of the candy has a boiling point sufficiently high that the liquid does not boil when contacted with hot candy to form the outer candy portion.

3. A chewy candy candy comprising a flavoring component consisting of a hydrophilic flavor encapsulated within a gelatin shell.

4. A gummy or jelly candy comprising a flavoring component consisting of a hydrophilic flavor encapsulated within a gelatin shell.

5. A paste lozenge comprising a flavoring component consisting of a hydrophilic flavor encapsulated within a gelatin shell.

6. A tablet candy comprising a flavoring component consisting of a hydrophilic flavor encapsulated within a gelatin shell.

7. A licorice candy comprising a flavoring component consisting of a hydrophilic flavor encapsulated within a gelatin shell.

8. A pan coated candy comprising a flavoring component consisting of a hydrophilic flavor encapsulated within a gelatin shell.

9. A candy having a liquid component, comprising:
a continuous outer candy portion,
an internal liquid flavoring portion, and
a natural polymer layer surrounding said liquid flavoring portion.

10. A candy according to claim 9 wherein the candy is selected from the group consisting of (1) hard candy, (2) chewy candy, (3) gummy or jelly candy, (4) paste lozenges, (5) tablet candy, (6) licorice, (7) pan coated candy.

11. A candy according to claim 9 wherein the natural polymer is cross-linked to a degree such that the natural polymer layer is effective to enable complete covering of the internal liquid flavoring portion of the candy without rupture of the polymer layer, but yet the polymer layer will permit clean mouth release of the internal liquid flavoring portion from the polymer.

12. A candy according to claim 9 wherein the liquid flavoring portion of the candy is of a flavor distinct from any flavor within the continuous outer candy portion.

13. A candy comprising a center filled liquid portion comprising a natural polymer shell surrounding an oil based flavorant.
